(19) United States
(12) Patent Application Publication
(10) Pub. No.: US 2016/0177952 A1
(43) Pub. Date: Jun. 23, 2016

(54) MOBILE SLUDGE EXHAUSTER AND METHOD

(71) Applicant: J. HVIDTVED LARSEN A/S, Silkeborg (DK)

(72) Inventor: Hans LARSEN, Silkeborg (DK)

(21) Appl. No.: 14/889,854

(22) PCT Filed: Dec. 18, 2014
(86) PCT No.: PCT/DK2014/050442

§ 371 Date: Nov. 8, 2015

(30) Foreign Application Priority Data
Jun. 25, 2014 (DK) PA 2014 00336

(51) Int. Cl. F04C 29/04; E03F 7/10; B60P 3/22; F04C 7/00; F04C 28/08

(52) U.S. Cl. CPC F04C 29/04; F04C 7/00; F04C 28/08; B60P 3/225; E03F 7/10

(57) ABSTRACT

The invention relates to a mobile sludge exhauster including a tank for collection of sludge from a device that contains sludge and a vacuum system (8) for creation of suction. Sludge is sucked up and transported in a pipe unit to the tank. The vacuum system (8) includes a vacuum pump (1) and an air inlet pipe (3) for creation of an underpressure and a medium outlet pipe (4). The vacuum system (8) includes a pressure sensor (5) for measuring the absolute pressure P1 in the air inlet pipe (3) or in the vacuum pump (1) and a control and adjustment unit (7) for registering the measured pressure P1 and for correction of the pump's (1) rotational speed. A sludge exhauster is hereby achieved, which functions no matter the atmospheric pressure.

### CROSS-REFERENCE TO RELATED APPLICATIONS

This application is a U.S. national state of International Appl. No. PCT/DK2014/050442 filed 18 Dec. 2014, which claimed priority to Danish Appl. No. PA 2014 00336 filed 25 Jun. 2014, which applications are incorporated herein by reference in their entireties.

### TECHNICAL FIELD

The invention relates to a mobile sludge exhauster including a tank for collection of sludge from a sludge containing unit, and a vacuum system for creating a suction, by which sludge is sucked up and transported in a pipe unit to the tank, which vacuum system includes a vacuum pump with a liquid medium and an air inlet pipe for establishing an underpressure and a medium outlet pipe, which vacuum system also includes a pressure sensor for measuring a pressure.

The invention also relates to a method for reduction of cavitation formation in a vacuum pump in a mobile sludge exhauster.

### BACKGROUND

Mobile sludge exhausters, such as sludge exhauster vehicles, are designed to be able to move from place to place regardless of conditions for sucking sludge saturated material up from for example sewer pipes. The sludge exhausters operate by using a vacuum suction pump such as a vane pump or a liquid ring pump, which creates a suction/negative pressure by use of added liquid, stop liquid, to the pump. An example of a mobile sludge exhauster is known from DK 176692.

The underpressure in the pump has to be adjusted continuously, such that the stop liquid in the pump does not boil at the specific vacuum. This boiling, called cavitation, has to be limited as much as possible, since the subsequent folding of the hereby formed steam bubbles will quickly destroy the pump.

The pump's rotation in itself will continuously create heat, which besides the thermodynamic compression will contribute to raising the temperature in the stop liquid. Therefore, the pump is often connected to a cooling system. The rotational speed of a liquid ring vacuum pump is often at a constant level mainly as a result of a cone belt transmission or a fixed hydraulic transmission.

The mobile sludge exhausters are provided with a measuring unit, which registers the difference between atmospheric pressure and working vacuum, and if it exceeds a specifically set value, a simple spring loaded safety vacuum valve will open for addition of flushing air from the atmosphere in to the working vacuum and thereby raise the absolute pressure on the pump's vacuum side. The risk of cavitation is thereby prevented.

The drawback of this is that the pump continues to work at full revolution and full effect with unchanged formation of heat and unchanged fuel consumption.

Since the vacuum safety valve thus operates on basis of the differential pressure in relation to the current atmospheric pressure, the risk of cavitation formation is increased. This should especially be seen in relation to that the atmospheric pressure will vary, determined by both the current barometer reading and the current height above the sea level. The sludge exhausters get around everywhere and thus also operate in areas with mountains and thereby in significant heights, where the atmospheric pressure is lower than at the sea surface. If a traditional vacuum safety valve is set for for example 0.15 bar absolute, which in practice is a fully normal applied value, it will be totally inoperative in 2 kilometers of height. Hereby, the safety vacuum valve becomes inoperative, and there can occur cavitation, whereby the pump is loaded. The load is comparable to a blast cleaning of the pump, and its service life will therefore be reduced significantly, if it does not break on the spot.

From JP2011252353 is known a mobile sludge exhauster, which among others includes a tank, a vacuum system and a vacuum pump and a pressure sensor, which measures the pressure in the system. The pump is, however, a liquid pump, and the pressure, which is measured, is not the absolute pressure. The described sludge exhauster does not solve the cavitation problem, which emerges in great heights, but will exactly by the preset pressure levels, which via the control unit give rise to a change of the rotational speed of the pump could result in that the pump breaks down in greater heights. And also, the cavitation which can occur in a liquid pump is basically very different from that, which can occur in a liquid ring pump, which is a type of air pump. Since a liquid pump only contains liquid, a potential cavitation will occur deep into the liquid, while a potential cavitation in a liquid ring pump will always occur in the boundary layer between liquid and the transported gas (air). The problem and the solution are therefore totally different.

### SUMMARY OF THE INVENTION

It is therefore the object of the present invention to create a system, which does not have the stated drawbacks or which at least creates a useful alternative.

This is achieved by a mobile sludge exhauster of the in the introduction stated and where the vacuum pump is a liquid ring pump and that the pressure meter is designed to measure the absolute pressure P1 in the air inlet pipe or in the vacuum pump and that the vacuum system also includes a control and adjustment unit for registration of the measured absolute pressure P1 and for correcting the pump's rotational speed and that the rotational speed chosen by the control and adjustment unit is a function of the absolute pressure P1 and the control and adjustment unit is designed to change the rotational speed when the registered absolute pressure P1 takes a given and predetermined value.

In this way it thus becomes possible to reduce the risk of cavitation formation and thereby that the pump collapses.

The correction arrangement thus consists of that the rotational speed of the pump is reduced if necessary all the way down to the minimum limit around 700-900 rpm, which occurs on the basis of the absolute pressure measured in the work vacuum and thus not by registration of a differential pressure relative to the atmosphere. At a reduced rotational speed, the air flow of the vacuum pump will be reduced and hereby, the degree of vacuum is reduced and thereby risk of cavitation formation. Secondarily, both energy and wear can be saved and it can be avoided that the pump becomes additionally heated. Heating of the pump is inappropriate and will reduce the possibility of achieving an acceptable vacuum.

The stop liquid is preferably water, which runs appropriately in a mostly closed circuit. Since there is some waste as a result of the heating, there occurs an addition of liquid to the work medium such that the amount of water is mostly constant.

If the adjustment precaution, the reduction of the pump's rotational speed, does not achieve to prevent the risk of cavitation sufficiently, the system can open for supply of flushing air through one or more valves, either on/off or analogue controlled, if one such is placed in the air inlet pipe. The adjustment can occur automatically by an inserted algorithm, which is adjusted to the conditions including the height in relation to the sea surface, which the mobile sludge exhauster operates in. An adjustment of the rotational speed is often carried out when the absolute pressure is in the area 0.1-0.2 bar absolute.

It is thus possible to use the mobile sludge exhauster to service mountain habitations in greater heights, where the liquid's boiling point can be significantly lower than low-lying localities near the sea surface.

By medium outlet pipe is understood an outlet pipe for discharge of air mixed with water vapour originating from evaporation of the stop liquid about 1 liter/hour.

By liquid medium is understood the stop liquid, which in the pump contributes to create the suction.

By vacuum is understood, in this connection, a pressure P, where P is larger than 0 bar but smaller than 1 bar.

In an additionally appropriate embodiment, the vacuum system of the mobile sludge exhauster includes at least one temperature measuring device for registration of the temperature T1 in the vacuum pump and/or in the medium outlet pipe and potentially a registration of the temperature T2 in the air inlet pipe.

The risk of cavitation in a liquid ring pump's stop liquid is dependent on the absolute pressure and on the stop liquid's temperature.

By including the temperature, a finer registration tool is now achieved for matching the optimum rotational speed of the liquid ring pump according to the risk of cavitation.

Since a possible cavitation in a liquid ring pump will occur in the boundary layer between stop liquid and air inside the pump, the cavitation risk, besides as mentioned above being effected by the temperature T1 in the stop liquid, furthermore be effected by the temperature T2 of the sucked in air, if T2 is different from T1. Therefore, it will be appropriate that the vacuum system can also include a temperature measuring device for registration of the temperature in the air inlet pipe. A temperature measuring device can thus be placed in the vacuum pump or in the medium outlet pipe and in the inlet pipe (potentially in all 3).

Appropriately, it is placed in the liquid pump and possibly supplemented with a temperature measuring device in the air inlet pipe.

It is hereby achieved that the temperature is included in the risk assessment of cavitation formation occurring.

By placement of temperature measuring device in both the air inlet pipe and in the pump (and/or in the outlet pipe), a registration occurs of both the absolute pressure and the temperature in the liquid ring vacuum pump's stop liquid and temperature in the inlet air, which acts as indicator for the risk of cavitation, whereafter the operator of the mobile sludge exhauster can choose to act accordingly, which means reducing the rotational speed, if a total assessment, meaning comparison with a known steam table curve with connected values for pressure, temperature—indicates a risk of cavitation. A reduction of the rotational speed will in itself contribute to reducing the heat generation in the pump and thereby also reduce the temperature or its pace of inclination in the liquid.

In an additionally preferred embodiment the control and adjustment unit of the mobile sludge exhauster is designed to change the rotational speed of the pump when T1 takes a value Tx and the absolute pressure takes a value Px, which values Tx, Px are predefined values situated above a steam curve for the medium, which is measured.

Hereby, the adjustment of the rotational speed can occur automatically, if the necessary parameters are programmed in an algorithm in the adjustment and control unit. The steam curve indicates risk of cavitation formation.

In an additionally preferred embodiment, the control and adjustment unit is designed to change the rotational speed of the pump when a corrected and calculated value T3, which temperature T3 is the temperature T1 corrected of temperature effect of the temperature T2 when a specific value Tx and the absolute pressure P1 takes a value Px, which values Px, Tx are predetermined values situated above a steam curve for the liquid medium, which change occurs automatically or manually.

Hereby, the T2 temperature's possible effect on the temperature conditions is included.

In an additionally preferred embodiment, the control and adjustment unit is an electronic control unit such as a PLC.

This is an appropriate choice for such a device.

In an additionally preferred embodiment, the air inlet pipe of the mobile sludge exhauster includes at least one safety vacuum valve for supply of air to the air inlet pipe, which safety vacuum valve is preferably an electrically controlled valve.

It is hereby achieved that a control of an air valve and its opening for supply of air can be included in the control and adjustment device and in such a way that the risk of cavitation is additionally reduced. In other words, the motor's rotational speed is adjusted in the same device, which adjusts the supply of air.

In an additionally preferred embodiment, the safety vacuum valve of the mobile sludge exhauster is designed for being opened at a critical level of the absolute pressure P1, which critical level indicates an area for cavitation formation.

In an additionally preferred embodiment, the safety vacuum valve is designed for being opened at a critical level of the absolute pressure P1 and at a temperature level measured in the vacuum pump and possibly in the medium outlet pipe and/or air inlet pipe, which critical level and temperature level state a level for cavitation formation.

This is relevant when the temperature is desired to be included for determining the risk of cavitation.

In a preferred embodiment example, the mobile sludge exhauster includes a cooling system including a cooling tank, in which cooling tank the liquid medium/the stop liquid is adjusted to an appropriate temperature, which temperature is the lowest that can be achieved.

The risk is hereby reduced of the temperature becoming so high that the rotational speed of the pump must be reduced too much. This will be inappropriate, since a lower rotational speed results in a lower suction effect and thereby a worse degree of utilization. The cooling system will always operate under application of the full capacity.

In a preferred embodiment example, the mobile sludge exhauster includes that the safety vacuum valve is designed to be opened at a critical level of the absolute pressure P1 and temperature T1 measured in the vacuum pump and also a temperature measuring device for registration of the temperature T2 in the air inlet pipe by which a temperature level is calculated, which critical level and which calculated temperature level indicates an area for cavitation formation.

The invention also relates to a method, for reduction of cavitation formation in a vacuum pump in a mobile sludge exhauster according to the above stated and where a pressure sensor is placed in the vacuum pump or the air inlet pipe that the pressure sensor measures the absolute pressure P1, that a control and adjustment unit changes the rotational speed of the vacuum pump when its absolute pressure P1 takes a specific value. It is hereby achieved that the work vacuum (the pressure) is held at a stabile level in an under pressure area, where there is not risk of cavitation formation. The adjustment can occur by an automatic or manual handling.

In an appropriate embodiment, the method includes, that a temperature measuring device placed in the vacuum system measures the temperature T1 of the liquid medium, the stop liquid, in the vacuum pump and/or the medium outlet pipe and possibly the temperature T2 in the air inlet pipe and that the control and adjustment device changes the rotational speed of the vacuum pump when the temperature T1 or the temperature T1 adjusted of the temperature T2 for achieving the temperature T3 when a specific value Tx and the absolute pressure P1 takes a value Px, which values Px, Tx are predetermined values situated above a steam curve for the liquid medium, which change occurs automatically or manually.

In a preferred embodiment, the method includes, that a temperature measuring device placed in the vacuum system measures the temperature T2 in the air inlet pipe to the vacuum pump, which temperature can be different from the temperature measured in the vacuum pump and/or in the medium outlet pipe.

In an additionally preferred embodiment, the method includes, that the control and adjustment unit changes the rotational speed of the vacuum pump when the temperature T1 adjusted for a possible influence of the temperature T2 by which a temperature T3 is registered and when a specific value Tx and the absolute pressure P1 takes a value Px, which values Px, Tx are predetermined values situated above a steam curve for the liquid medium, which change occurs automatically or manually.

In an additionally preferred embodiment, the method includes, that the air inlet pipe includes at least one safety vacuum valve, through which, air can be supplied to the air inlet pipe, which safety vacuum valve is opened for supply of air when the absolute pressure P1 has reached a predetermined value, where there is risk of cavitation.

In a preferred embodiment example, the method includes that the temperature of the liquid medium is adjusted to a lowest achievable temperature by the stop liquid being led to a cooling system by which the medium liquid's temperature is reduced as much as possible.

Hereby, the risk is reduced of the temperature becoming so high that the rotational speed of the pump must be reduced too drastically. This will be inappropriate, since a lower rotational speed results in a lower suction effect and thereby a worse degree of utilization.

### BRIEF DESCRIPTION OF THE DRAWINGS

The invention will now be explained more fully with reference to the drawing where

FIG. 1 shows a simplified diagram of a vacuum system for use in a mobile sludge exhauster according to the invention.

FIG. 2 shows an example of a vacuum pump for use in a mobile sludge exhauster according to the invention.

FIG. 3 shows a simplified steam table curve for a stop liquid.

### DETAILED DESCRIPTION OF THE INVENTION

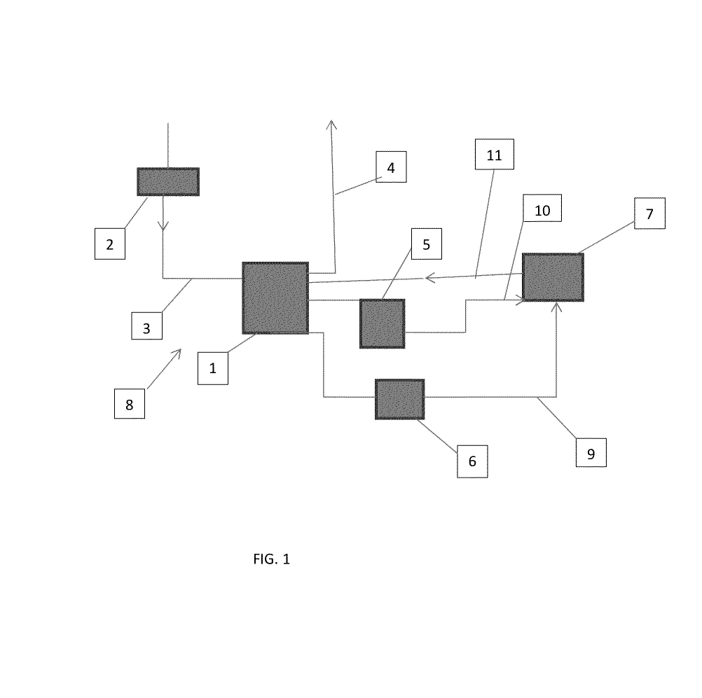

FIG. 1 shows simplified diagram of a vacuum system 8 for placement in a mobile sludge exhauster, as it is known for example from DK176692. The tank for collection of sludge and transport conduct of the sludge is not shown on the drawing. The vacuum system 8 includes a vacuum pump 1, a liquid ring pump, which is provided with operating fluid/stop liquid consisting of water. The pump 1 is provided with energy from a diesel motor or similar (not shown on the drawing). Evaporated operating fluid and air leave the vacuum system via a medium outlet pipe 4. The pump 1 thus functions according to known principles.

The pump creates suction/underpressure at an air inlet pipe 3, which is connected to the tank for collection of the sludge.

In the pump 1 or the air inlet pipe 3 is placed a pressure sensor 5, which measures the absolute pressure in the pump 1. This pressure is subsequently registered via an input signal line 10 in a control and adjustment unit 7. If the pressure is inappropriate, the control and adjustment unit 7, typically consisting of a PLC, will either automatically or by a manual operation via an output signal line 11 change the pump's 1 rotational speed. The pump 1 will at maximum performance typically be at maximally 2000 rpm. and can by reduction reach as low as 700-900 rpm. The vacuum system 8 can also include a temperature measuring device 6, which registers the temperature in the system 8 and sends result to the control and adjustment unit 7 via an input signal line 9. At a temperature and an absolute pressure, which are close to the boiling point of the stop liquid and whereby there is risk of cavitation formation, the PLC control will reduce the pump's rotational speed and thereby reduce the heat generation. The control and adjustment unit 7 will therefore become activated either manually or automatically if it is set to react at a specific steam curve. The control and adjustment unit 7 can also be set to react only on the absolute pressure.

The temperature measuring device is appropriately placed in the medium outlet pipe 4 or in the pump 1, preferably in the pump 1. A temperature measuring device can also be placed in the air inlet pipe 3. The temperature measured here T2 will often be another than the one, which is measured in the pump 1 (in in the medium outlet pipe 4). An adjusted temperature T3 can be calculated, which is the temperature T2 adjusted for T3's effect.

The control and adjustment unit 7 is designed to change the rotational speed of the pump 1 when T1, or the adjusted temperature, takes a value Tx and the absolute pressure P1 takes a value Px, which values Tx, Px are predetermined valued situated above a steam curve for the medium which is measured. The pump system 8 also includes, in this example, a safety vacuum valve 2 connected to the air inlet pipe 3, which is set to be able to open at risk of cavitation formation. The valve 8 is electrically controlled and also connected to the PLC control 7.

The pump system 8 preferably also includes a cooling system, which includes a cooling pipe for supply of liquid from a cooling tank and for cooling of the vacuum pump. The cooling system also includes an outlet pipe for leading back the liquid to the cooling tank. The cooling system is not shown on drawing.

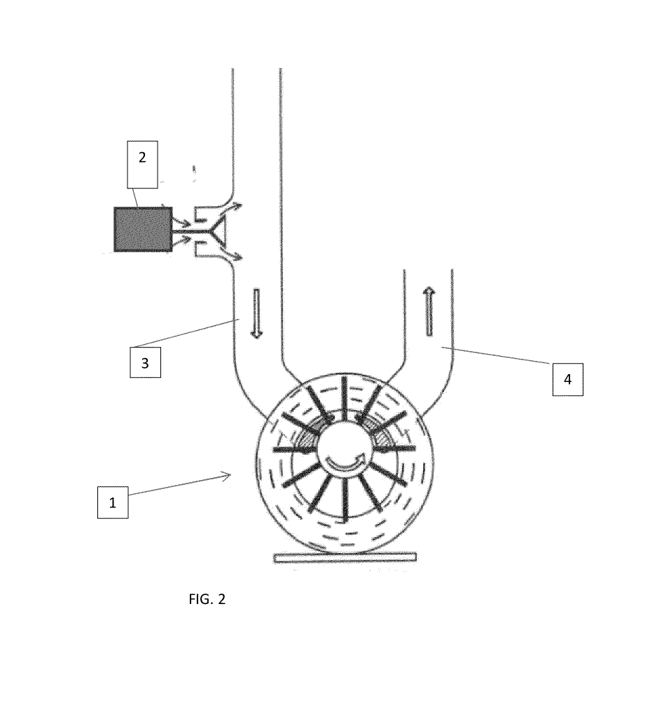

FIG. 2 shows a liquid ring pump 1, which with advantage can be used for the principle shown in FIG. 1. The liquid ring pump 1 is a well known pump.

Reference numbers on drawing are the same, which are valid for FIG. 1. If the underpressure in the air inlet pipe 3 becomes too high even at minimum rotations, the valve 2 will open and limit the underpressure such that it reaches an acceptable level.

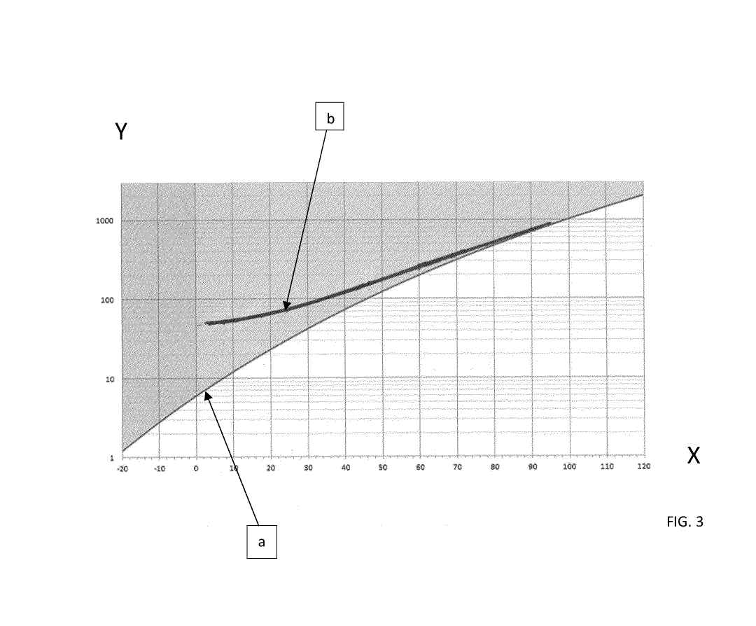

FIG. 3 shows a simplified steam table curve and is relevant when the temperature is included to reduce the risk of cavitation formation. The critical for cavitation is the boiling point, determined by pressure and temperature. The temperature is shown out from the x-axis in degrees Celsius and the pressure out from the y-axis in bar. The curve marked a indicates the boiling point of the medium and curve marked b is an example of an imaginary “safety curve”, which lies for example 0.05 bar above the boiling point. The invention ensures that a position “above” this curve is always achieved.

### REFERENCE NUMBERS

1 Vacuum pump
2 Safety vacuum valve
3 Air inlet pipe
4 Medium outlet pipe
5 pressure sensor/meter
6 temperature measuring device
7 Control and adjustment unit (PLC)
8 Vacuum system
9 Input signal line (T)
10 Input signal line (P)
11 Output signal line

1.-15. (canceled)

16. A mobile sludge exhauster, comprising:
a tank for collection of sludge from a sludge containing unit, and
a vacuum system for creating a suction, by which sludge is sucked up and transported in a pipe unit to the tank,
wherein the vacuum system comprises a vacuum pump with a liquid medium and an air inlet pipe for establishing an underpressure, a medium outlet pipe and a pressure sensor for measuring a pressure,
wherein the vacuum pump is a liquid ring pump and the pressure meter is designed to measure the absolute pressure P1 in the air inlet pipe or in the vacuum pump,
wherein the vacuum system further comprises a control and adjustment unit for registration of the measured absolute pressure P1 and for correcting the pump's rotational speed, and
wherein the rotational speed chosen by the control and adjustment unit is a function of the absolute pressure P1 and the control and adjustment unit is designed to change the rotational speed when the registered absolute pressure P1 takes a given and predetermined value.

17. The mobile sludge exhauster according to claim 16, wherein the vacuum system further comprises at least one temperature measuring device for registration of the temperature T1 in the vacuum pump and/or in the medium outlet pipe, and for a registration of the temperature T2 in the air inlet pipe.

18. The mobile sludge exhauster according to claim 17, wherein the control and adjustment unit is designed to change the rotational speed of the pump when T1 takes a value Tx and the absolute pressure P1 takes a value Px, which values Tx, Px are predefined values situated above a steam curve for the medium, which is measured.

19. The mobile sludge exhauster according to claim 17, wherein the control and adjustment unit is designed to change the rotational speed of the pump when a corrected and calculated value T3, which temperature T3 is the temperature T1 corrected of temperature effect of the temperature T2 when a specific value Tx and the absolute pressure P1 takes a value Px, which values Px, Tx are predetermined values situated above a steam curve for the liquid medium, which change occurs automatically or manually.

20. The mobile sludge exhauster according to claim 16, wherein the control and adjustment unit is an electric control unit such as a PLC.

21. The mobile sludge exhauster according to claim 16, wherein the air inlet pipe includes at least one safety vacuum valve for supply of air to the air inlet pipe, which safety vacuum valve is an electrically controlled valve.

22. The mobile sludge exhauster according to claim 21, wherein the safety vacuum valve is designed to open at a critical level of the absolute pressure P1 and which critical level indicates an area of cavitation formation.

23. The mobile sludge exhauster according to claim 21, wherein the safety vacuum valve is designed for being opened at a critical level of the absolute pressure and at a temperature level measured in the vacuum pump and/or the medium outlet pipe, and in the air inlet pipe which critical level and temperature level state an area for cavitation formation.

24. The mobile sludge exhauster according to claim 16, further comprising a cooling system including a cooling tank, in which cooling tank the liquid medium and the stop liquid is adjusted to an appropriate temperature, which temperature is the lowest that can be achieved.

25. A method for reduction of cavitation formation in a vacuum pump in a mobile sludge exhauster according to claim 16, wherein a pressure sensor is placed in the vacuum pump or the air inlet pipe that the pressure sensor measures the absolute pressure P1, that a control and adjustment unit changes the rotational speed of the vacuum pump when its absolute pressure P1 takes a specific value.

26. The method according to claim 25, wherein at least one temperature measuring device placed in the vacuum system measures the temperature T1 of the liquid medium, the stop liquid, in the vacuum pump and/or the medium outlet pipe and the temperature T2 in the air inlet pipe, and wherein the control and adjustment device changes the rotational speed of the vacuum pump when the temperature T1 or the temperature T1 adjusted of the temperature T2 for achieving the temperature T3 when a specific value Tx and the absolute pressure P1 takes a value Px, which values Px, Tx are predetermined values situated above a steam curve for the liquid medium, which change occurs automatically or manually.

27. The method according to claim 26, wherein a temperature measuring device placed in the vacuum system measures the temperature T2 in the air inlet pipe to the vacuum pump, which temperature T2 can be different from the temperature T1 measured in the vacuum pump and/or in the medium outlet pipe.

28. The method according to claim 26, wherein the control and adjustment unit changes the rotational speed of the vacuum pump when the temperature T1 adjusted for a possible influence of the temperature T2 by which a temperature T3 is registered and when a specific value Tx and the absolute pressure P1 takes a value Px, which values Px, Tx are predetermined values situated above a steam curve for the liquid medium, which change occurs automatically or manually.

29. The method according to claim 25, wherein the air inlet pipe includes at least one safety vacuum valve, through which, air can be supplied to the air inlet pipe, which safety vacuum valve is opened for supply of air when the absolute pressure P1 has reached a predetermined value, where there is risk of cavitation.

30. The method according to claim 25, wherein the temperature of the liquid medium is adjusted to a lowest achievable temperature by the liquid medium being led to a cooling system by which the liquid's temperature is reduced as much as possible.
